(19) United States
(12) Patent Application Publication
(10) Pub. No.: US 2012/0162999 A1
(43) Pub. Date: Jun. 28, 2012

(54) RECESSED LUMINAIRE WITH TRIM RETAINING MECHANISM AND METHOD THEREOF

(75) Inventor: Scott R. Dupre, Fall River, MA (US)

(73) Assignee: KONINKLIJKE PHILIPS ELECTRONICS N.V., EINDHOVEN (NL)

(21) Appl. No.: 12/976,131

(22) Filed: Dec. 22, 2010

(51) Int. Cl. F21V 15/01

(52) U.S. Cl. 362/365

(57) ABSTRACT

A recessed luminaire installation mechanism comprising, at least one post (46) extending from one of a trim (20) or a trim ring (40), at least one track (32,132) for receiving the at least one post (46,146), the track disposed on the other of said trim or said trim ring, the at least one track being generally helical to vary a height of the trim relative to a luminaire can (12) when the trim is rotated about a vertical axis (V_{A}).

### CROSS-REFERENCE TO RELATED DOCUMENTS

None.

### TECHNICAL FIELD

The present invention relates to a recessed luminaire. More specifically, the present invention relates to recessed luminaire which includes a trim retaining mechanism for tightening a trim flange against a ceiling.

### BACKGROUND

When installing a recessed luminaire, currently trim elements are positioned in the can and are held in place by various means. Unfortunately, the trims usually move downward relative to the can and ceiling for two reasons. First, during installation an upward force is provided on the trim. At some point during installation, the upward force is removed causing the trim to typically drop a small distance. Second, over time and due to heat created by the luminaire, the retaining means typically relax allowing the trim to sag even further below the ceiling line. Either or both of these scenarios create an undesirable gap between the trim and the ceiling, which is aesthetically unpleasant and may hinder performance.

Additionally, it is known that when a removing a trim element from a recessed luminaire, for maintenance of ballasts, LED drivers and the like, maintenance personnel may place reckless downforce on the trim to pull the trim from the can. This can damage the retaining mechanism holding the trim in the luminaire can.

In either event, the sagging of trim elements may cause light leakage which is undesirable. Such leakage can reduce the performance of the luminaire. Additionally, such sagging may make a gap visible between can and ceiling. Accordingly, it would be highly desirable that some structure be provided which retains the trim mechanism tightly against the ceiling and which also allows for consistent removal for maintenance procedures.

### SUMMARY

A recessed luminaire installation mechanism comprises at least one post extending from one of a trim or a trim ring, at least one track for receiving the at least one post, the track disposed on the other of said trim or said trim ring, the at least one track being generally helical to vary a height of the trim relative to a luminaire can when the trim is rotated about a vertical axis. The recessed luminaire installation mechanism wherein the trim ring comprises a plurality of posts extending radially inward. The recessed luminaire of installation mechanism wherein the trim ring further comprises a plurality of springs depending from the ring. The recessed luminaire installation mechanism further comprising a spring retaining member on the trim ring. The recessed luminaire installation mechanism wherein the at least one track has a vertical portion. The recessed luminaire installation mechanism wherein the at least one track has a being a slot which receives the post. The recessed luminaire installation mechanism wherein the at least one track is three tracks. A recessed luminaire installation mechanism wherein the at least one track is located in the luminaire trim.

A recessed luminaire installation mechanism comprises a recessed luminaire can, a trim ring positioned within the can, the trim ring defining a first portion of a rotatable trim retaining mechanism, a trim having a second portion of a rotatable trim retaining mechanism, the trim engaging the trim ring to retain the trim within the can, the trim being rotatable relative to the trim ring causing the trim to move from a first vertical position to a second vertical position, one of the first vertical position and the second vertical position disposing a trim flange against a lower ceiling surface. The recessed luminaire installation mechanism wherein the trim ring further comprises a plurality of springs. The recessed luminaire installation mechanism wherein the trim ring has one of a post or a thread and the trim having the other of the post or the thread. The recessed luminaire installation mechanism of Claim 11 further comprising a starter thread disposed on the one of the trim and the trim ring. The recessed luminaire installation mechanism wherein the starter thread is vertical. The recessed luminaire installation mechanism wherein the starter thread is on an angle to a vertical axis. The recessed luminaire installation mechanism wherein the starter thread is in communication with the track.

A recessed luminaire installation mechanism comprises a luminaire can having an opening at one end, a trim ring having at least one spring which engages an inner surface of the luminaire can, a trim structure positioned within the luminaire can, the trim structure received by the trim ring, an engaging structure extending from one of the trim ring and the trim structure, a receiving structure disposed on the other of the trim ring and the trim structure, the receiving structure receiving the engaging structure, the receiving structure comprising a slot which extends partially circularly so that rotation of the trim structure causes the trim structure to raise or lower from one of a first and second vertical position to the other of the first and second vertical position. The recessed luminaire wherein the receiving structure comprises at least one helical slot. The recessed luminaire wherein the receiving structure further comprises a vertical slot portion. The recessed luminaire wherein rotation of the trim structure tightens the trim structure against the ceiling. The recessed luminaire wherein the engaging structure is positioned on the trim ring. The recessed luminaire wherein the engaging structure is positioned on the trim structure. The recessed luminaire further comprising at least one protuberance along the receiving structure. The recessed luminaire wherein the receiving structure comprises a frictional increasing surface.

A method of installing a recessed luminaire trim comprises installing a recessed luminaire can into a ceiling, positioning a trim within the recessed luminaire can, rotating the trim to raise the trim from a first position to a second position, engaging the ceiling with a trim flange at said second position.

A method of installing a recessed luminaire trim comprises positioning a trim ring within a recessed luminaire can, installing a recessed luminaire into a ceiling, positioning a trim into a trim ring, rotating the trim ring relative to the trim ring, raising the trim relative to the trim ring to engage a surface of a trim flange with the ceiling.

### BRIEF DESCRIPTION OF THE ILLUSTRATIONS

In order that the invention may be better understood, embodiments of the Recessed Luminaire with Trim Retaining Mechanism and methods thereof in accordance with the present invention will now be described by way of examples. These embodiments are not to limit the scope of the present invention as other embodiments of the Recessed Luminaire will become apparent to one having ordinary skill in the art upon reading the instant description. Examples of the present invention are shown in figures wherein

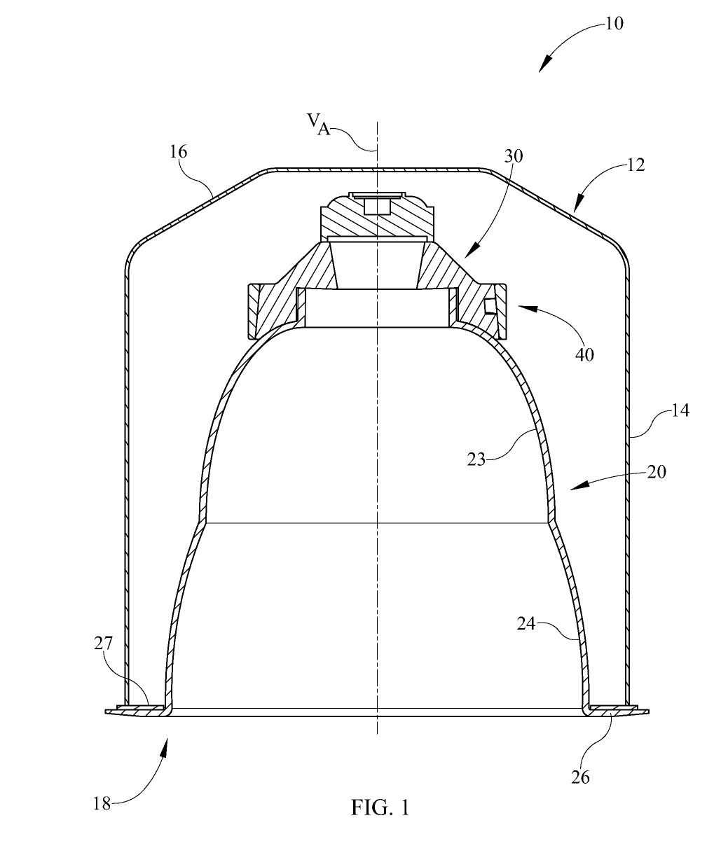

FIG. 1 depicts a side sectional view of a recessed luminaire;

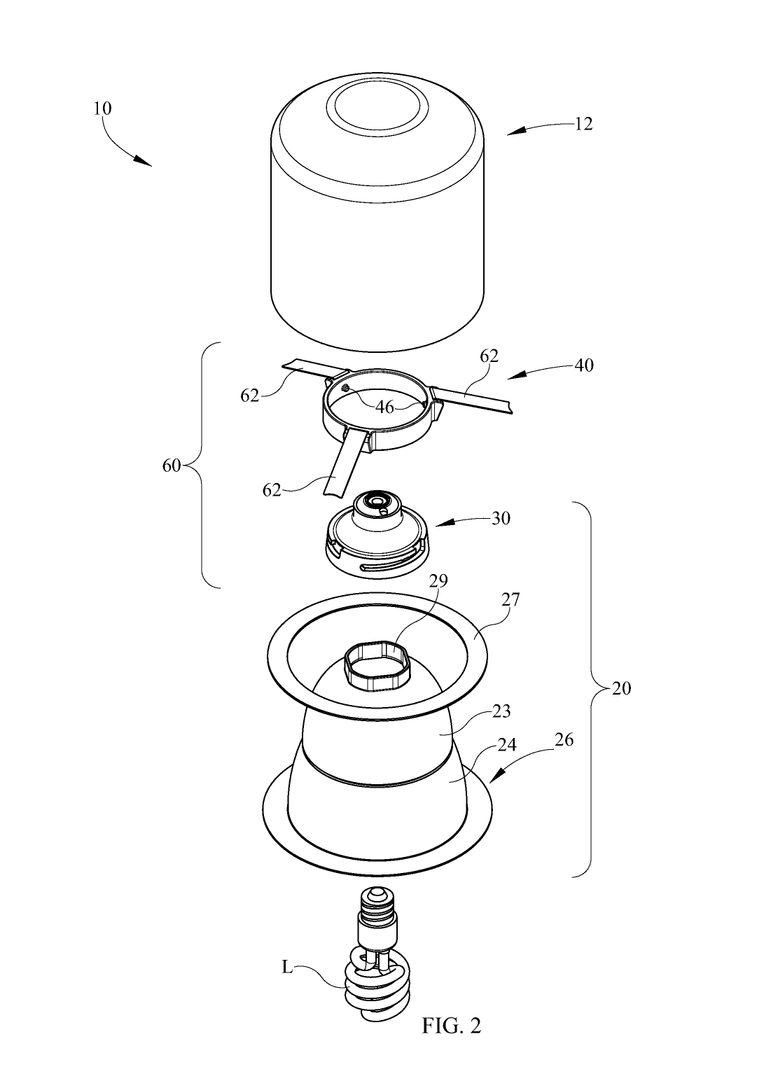

FIG. 2 depicts an exploded perspective view of a recessed luminaire with trim retaining mechanism;

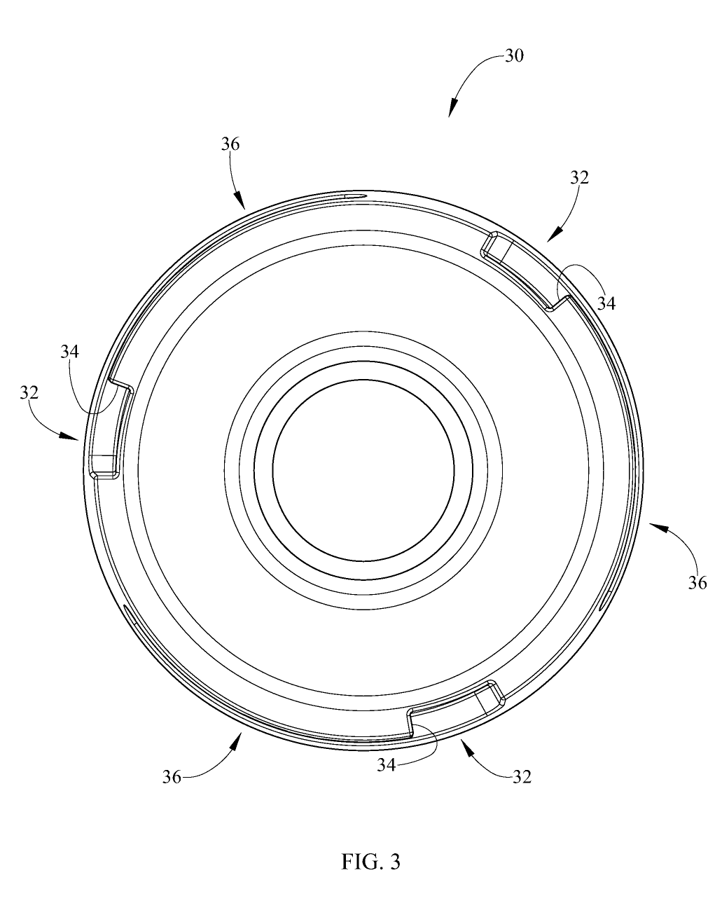

FIG. 3 depicts a top view of the trim cap defining a portion of the trim retaining mechanism;

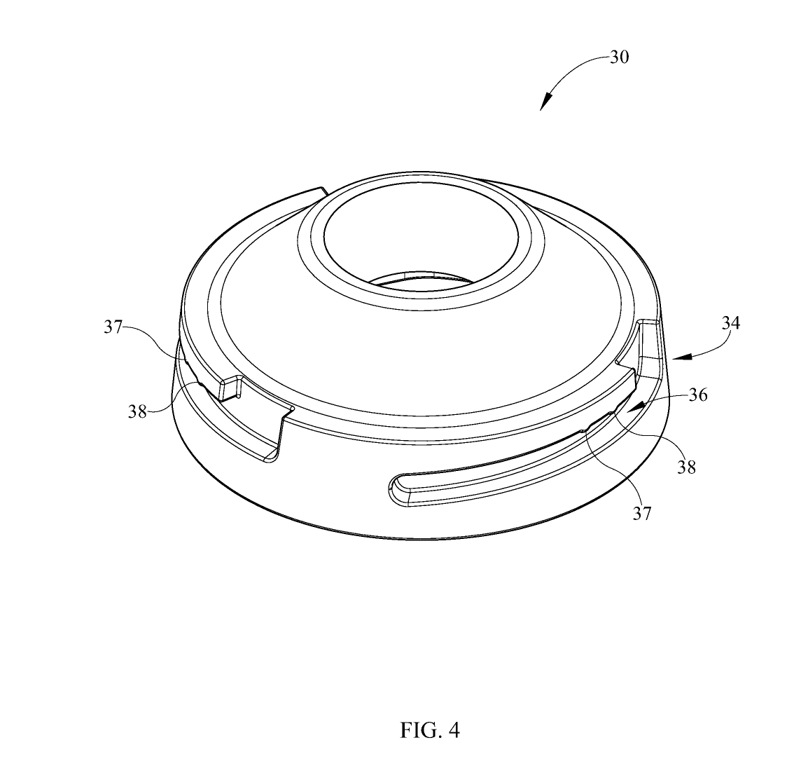

FIG. 4 depicts a perspective view of the trim cap of FIG. 3;

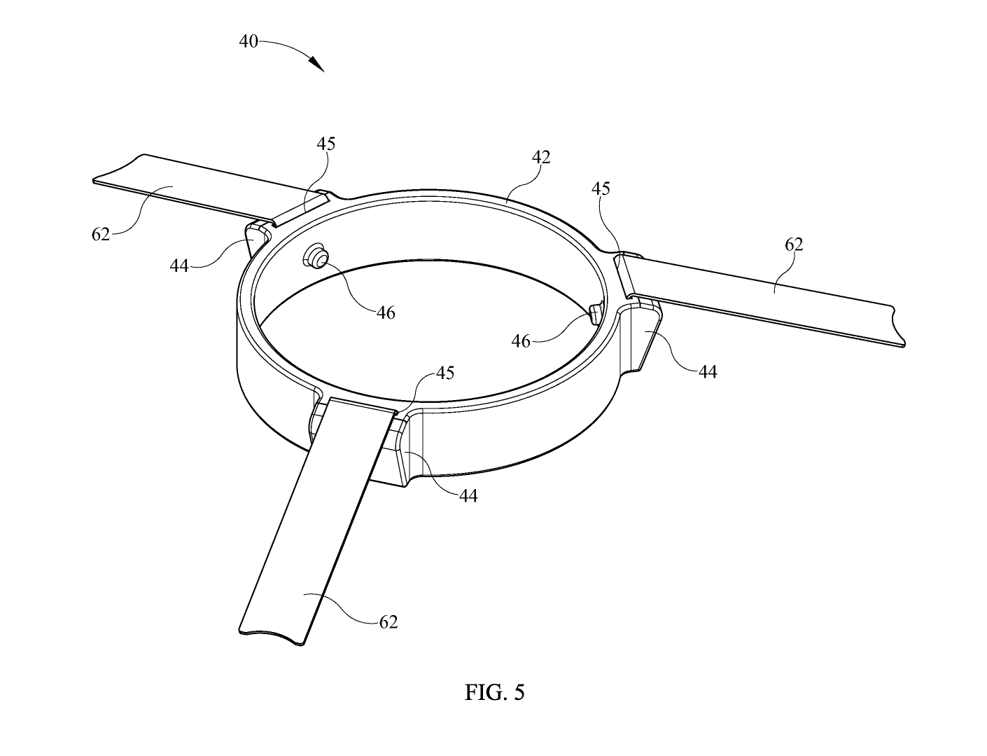

FIG. 5 depicts a perspective view of the trim ring structure defining a portion of the trim retaining mechanism;

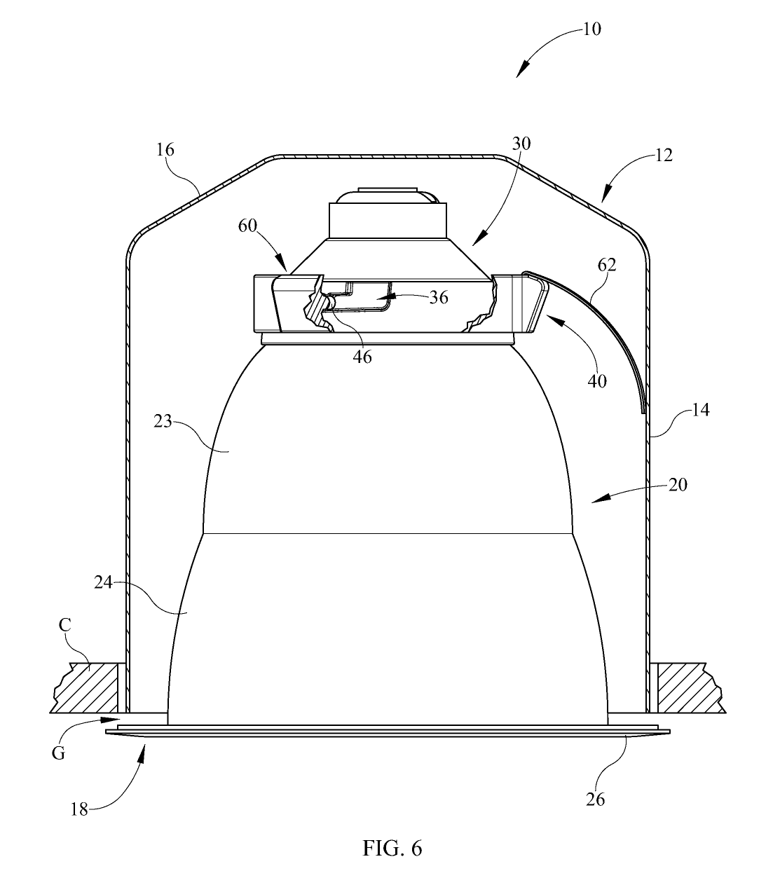

FIG. 6 a side view of the recessed luminaire with the trim in a first position with respect to the ceiling;

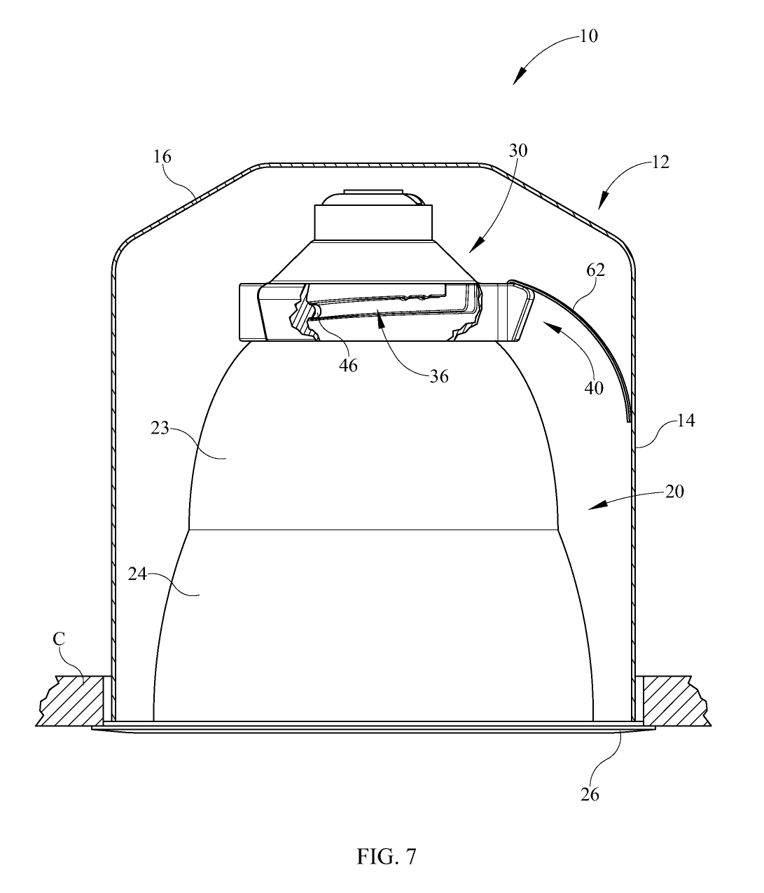

FIG. 7 depicts a side view of the recessed luminaire with the trim in a second position with respect to the ceiling;

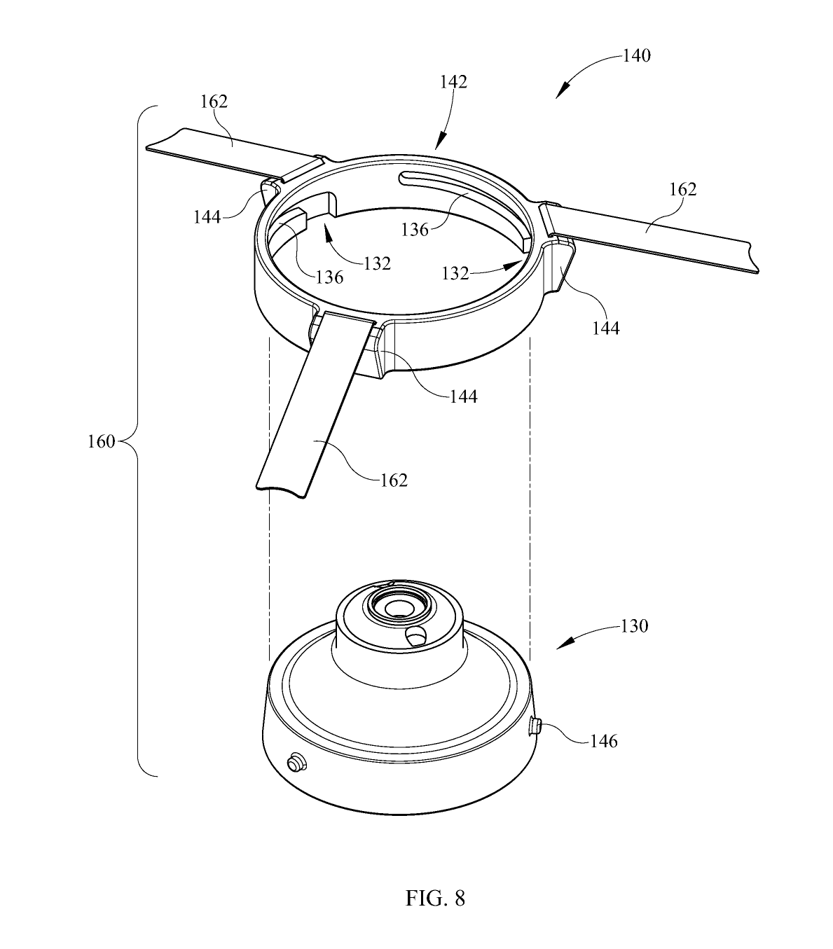

FIG. 8 depicts an alternative embodiment of the retaining structure;

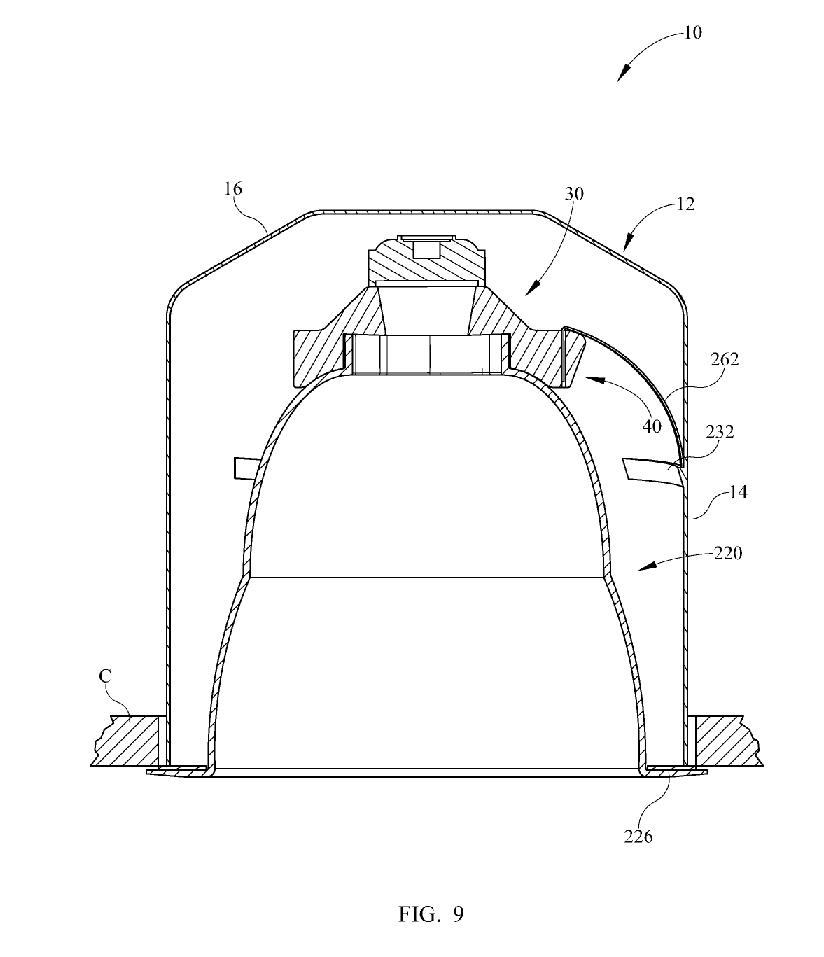

FIG. 9 depicts a method flowchart for using the movable floor of the rotary grinder; and,

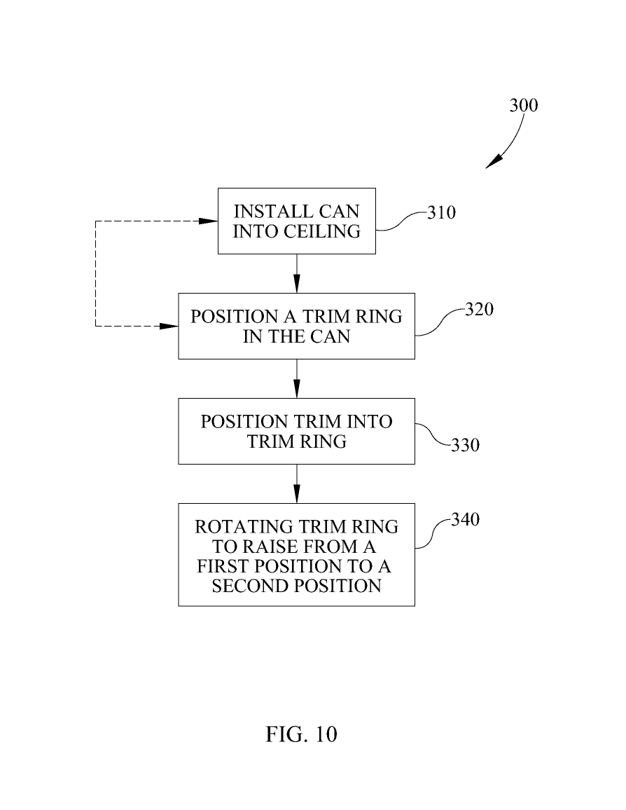

FIG. 10 depicts a further embodiment of a trim retaining mechanism.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Referring now to FIGS. 1-10, various views and embodiment are depicted of a recessed luminaire allowing for easy installation and method for tightening a flange to a ceiling. A recessed luminaire utilizes a trim retaining mechanism which allows the trim flange to be pulled tightly against the ceiling rather than sagging away from the ceiling, as is problematic with state of the art recessed luminaires. As a result, this allows the flange to remain tight against the lower surface of the ceiling and eliminates any light leakage there between.

Referring now to FIG. 1, a side-sectional view of a recessed luminaire 10 is depicted. The luminaire 10 includes a can 12 which is generally circular in shape having a sidewall 14 and an upper portion 16 closing the upper end of the can 12. The lower end 18 of a can 12 is open and receives various luminaire structures described further herein. The can 12 is generally hollow with circular cross-section and may be formed of various lightweight rigid materials capable of withstanding luminaire temperatures. These descriptions are exemplary and should not be considered limiting.

A trim 20 is positioned within the can 12. The trim 20 comprises a reflector which may be formed of one or more pieces. For example, the trim 20 includes a reflector upper portion 23 and a reflector lower portion 24. These may be a unitary structure or it may be two or more pieces connected together in various means. The trim may be formed of various reflective materials and may be diffuse or specular and further may be formed in a variety of shapes which are usable with the can 12. A diffuser (not shown) may be positioned within the trim 20 as well.

At a bottom of the reflector 20 is a trim flange 26 extending radially outward. The trim flange 26 may be unitary with the reflector 20 and covers an opening in the ceiling allowing positioning of the can 12. This trim flange 26 has an upper surface and a lower surface wherein the upper surface may abut a lower surface of a ceiling and may extend outwardly radially beyond the diameter of the can 12. The can 12, however, may be various geometric shapes and therefore the term diameter is used in an exemplary manner. One skilled in the art will realize that the trim flange 26 should extend outwardly beyond the perimeter of the can 12.

At an upper portion of the reflector 22, the trim further includes a trim cap 30. The trim cap 30 receives a trim ring 40. The trim cap 30 and trim ring 40 together form a trim retaining mechanism to allow raising of the trim 20 from a first position to a second position tightly against a ceiling (FIGS. 6, 7) with rotation about axis V_{A}. Alternatively, the trim 20 may be lowered from the ceiling in order to ease maintenance and reduce uneven pulling force on the trim 20 when the trim 20 needs to be removed for example during maintenance procedures. Removed from FIG. 1, a lamp L (FIG. 2) is disposed in the trim cap 30 by means of a socket (not shown). The lamp may take various forms alternative to that which is shown and therefore the lamp shown in FIG. 2 should not be considered limiting. The socket may be electrically connected to a driver, ballast and/or other electronic component for illuminating the lamp L and positioned within the trim cap.

Also shown in FIG. 1 is a gasket 27. Some jurisdictions require a gasket between the flange 26 and ceiling to inhibit air transfer, heat transfer and limit fire spread. Such gasket 27 may be used in those jurisdictions.

Referring now to FIG. 2, the recessed luminaire 10 is depicted in exploded perspective view. At the top of the figure, the can 12 is shown with the interior components removed. The trim 20 is depicted at the lower end of the figure with a trim flange 26 at a lowermost end thereof. Extending upward from the flange 26 is the reflector 23, 24. The upper portion of the trim 20 includes an upwardly extending portion 29 which receives the trim cap 30. The trim cap 30 is connected to the trim 20 and provides one means of moving the trim 20 relative to the can 12 and to a ceiling surrounding the can 12 and adjacent the trim flange 26. The trim cap 30 also functions to close the upper portion of the trim 20 and provide a location for a luminaire socket and luminaire.

The trim ring 40 and trim cap 30 work in unison to provide the trim retaining mechanism 60. The trim ring 40 engages the trim cap 30 and allows movement of the trim 20 relative to the can 12 and ceiling (not shown) in a vertical fashion. The trim retaining mechanism 60 further holds the trim 20 tightly against the lower surface of the ceiling.

Referring now to FIG. 3, a top view of the trim cap 30 is depicted. This description is provided in combination with the perspective view of the trim cap 30 shown in FIG. 4. The trim cap includes at least one track or thread 32. The at least one track or thread 32 includes a starter thread 34 and a generally helical slot or thread portion 36. The starter thread 34 is generally vertical in construction and receives a post structure on the trim ring 40 (FIG. 2). Alternatively, the starter thread or starter track 34 may be angled so that the trim ring 40 moves between a first position and a second position to enter the thread 36. The thread 36 further moves the trim 20 between a first vertical position and a second vertical position by rotation of the trim 20 relative to the stationary trim ring 40. Thus, as the trim 20, including trim cap 30, engages the trim ring 40, the trim 20 moves between a first position vertically and a second position at which point the trim 20 engages the upper surface of the ceiling tightly so as to inhibit sagging of the trim as the trim ring 40 sags or springs relax within the can 12. In the present embodiment the trim cap 30 comprises three tracks or threads 32 spaced apart a preselected distance.

Located within the at least one thread 36 are first and second stops 37, 38. The first and second stops capture a post 46 (FIG. 5) of the trim ring 30 during manufacturing so that the trim ring 30 is restrained relative to the trim cap 30 and cannot become dislodged during shipping. The first and second stops 37, 38 capture the post 46 there between to hinder movement relative to the two parts. At time of installation, the captured post 46 may be removed from thread 36 by rotation and starter portion 34 so that the trim 20 may be removed from the trim ring 40 and the can 12. For re-installation, the post 46 is positioned into starter thread 34 and the trim 20, including trim cap 30, is rotated so that the post 46 moves through the thread 36. The post 46 moves beyond the capture position between the first stop and second stop 37, 38 and toward the lowermost end of the track 36. The post 46 will continue to move along the track or thread 36 until the trim flange 26 (FIG. 2) engages, the lower surface of the ceiling. The frictional engagement between the upper surface of the thread 36 and the post 46 will maintain positioning of the trim flange 26 tightly against the ceiling.

Referring now to FIG. 5, a perspective view of the trim ring 40 is depicted. The trim ring 40 is stationary and positioned within the can 12 so that the trim 20 can move relative to the can 12, trim ring 40 and ceiling (FIGS. 6, 7). The trim ring 40 includes a ring 42 which is circular in shape and may be formed of various materials including metallic or molded plastics or other known materials which can withstand heat and are lightweight. The ring 42 includes at least one spring retaining mechanism 42. In the embodiment described, the spring retaining mechanisms 44 are disposed about the outer circumference of the ring 42 about 120 degrees apart. Each of the at least one spring retaining mechanism 44 may be fastened to the ring 42, or alternatively may be formed integrally therewith. The exemplary spring retaining mechanisms 44 include an opening 45 along an upper edge so as to receive the springs 62. The at least one spring 62 is shown as three springs in the exemplary embodiment. The three springs 62 are metallic or other flexible but resilient material which frictionally engages or bite along the interior surface of the can 12 (FIG. 1) when the trim ring 40 is inserted into the can 12. Extending radially inwardly from the inner surface of the ring 42 is at least one post 46. The post may be fastened to or formed integrally with the ring 42. The posts are generally circular in cross-section but various shapes may be utilized that cooperate and can move within the threads or tracks 32. In the exemplary embodiment, three posts 46 are utilized corresponding to the three tracks 32 of the trim cap 30 however this number may be varied. As the trim 20 moves upward into can 12, the posts 46 are positioned through the starter thread 34 and into the thread 36 of each track 32. The trim ring 40 remains stationary within the can 12 and the trim 20 may be rotated relative to the posts 46 and trim ring 40 so that the posts 46 move through the threads 32 when the trim 20 is rotated. During such rotation, the trim 20, and specifically the trim flange 26, moves from a first lower position relative to the ceiling to a second upper position pressed against the lower surface of the ceiling. The frictional engagement of the flange 26 against the ceiling and the post 46 engagement with the thread 36 retain the trim flange 26 against the ceiling and inhibit downward movement thereof. When the trim 20 needs to be removed for maintenance, the trim 20 is rotated in the opposite direction so as to lower the trim flange 26 relative to the ceiling and can 12.

Referring now to FIG. 6, a side sectional view of the recessed luminaire 10 with trim retaining mechanism is shown. Within the can 12, the trim 20 is positioned and the flange 26 is spaced from the lower surface of the ceiling C. At the top of the trim 20, the trim ring 40 is shown cut away in part to reveal the thread 32 of the trim cap 30. In the condition depicted, the post 46 is shown in the thread 32 just beyond the starter thread 34 and into the helical portion 36. The spacing between the flange 26 and the ceiling C is depicted by gap G.

Referring now to FIG. 7, the luminaire 10 is again shown in side sectional view. The trim 20 is rotated some radial distance about a vertical axis so that the thread 32 moves relative to the stationary post 46. As this occurs, the trim 20, including flange 26, move upwardly within the can 12 and the trim flange 26 abuts the lower surface of the ceiling. If maintenance is needed wherein the trim 20 must be removed, the trim 20 may simply be rotated in the opposite direction until the post 46 reaches the starter thread 34 and the trim 20 may be lowered.

Referring now to FIG. 8, an alternative embodiment of the trim retaining mechanism 160 is depicted. In the previous embodiment, the track is rotated relative to the stationary posts. In the instant embodiment, the track is stationary and the posts move relative to the track. A trim ring 140 is shown above a trim cap 130 defining the trim retaining mechanism. The trim ring 140 includes a ring structure 142 and spring retaining mechanisms 144 having the connected springs 162 as previously described. Positioned along the inner surface of the ring 142 is at least one track or thread 132. The track 132 includes a starter portion 134 extending toward a lower edge of the ring 142 and a generally helical thread 136 as previously described. In the embodiment, since the trim ring 140 receives the trim cap 130 from below, the starter threads 134 must extend from the lower edge of the ring 142. As with the previous embodiment, the amount of rotation needed to raise or lower the trim depends on the angle of threads and axial height of the ring 142.

Beneath the trim ring 140 is the trim cap 130. Extending from the trim cap 130 are posts 146 which may be aligned with and enter into the track or thread 132. This combination allows a rotational force to raise and lower the trim and flange so that the flange engages the ceiling tightly and inhibits gaps due to sagging of the trim.

Referring now to FIG. 9, in yet a further alternative, the trim, trim cap and trim ring may all be fixed relative to one another. On an inner surface of the can are threads, ribs or protuberances 232 at a specific height and may extend helically upwardly therefrom. The spring 262 may extend from the trim ring to engage the threads, tracks, channels, ribs or protuberances when the trim is inserted into the can a preselected distance. Once the springs 262 engage the can threads 232, the trim 220 may rotated an amount dependent on the pitch and angle of the threads 232 to raise the trim 220. This rotation may continue until the trim flange engages the lower surface of the ceiling.

In operation, and with reference to FIG. 10, the can 12 may be installed into the ceiling at step 310. Next a trim ring 40, 140 is installed into the can 12 at step 320. A broken line with double arrowheads is shown between steps 310 and 320 as the order of these steps may be reversed. Next, the trim 20, including trim cap 30, 130 is positioned into the can 12 and engages trim ring 40, 140. In the next step, the trim 40, 140 is rotated about a vertical axis to as to move the trim 20 from a first lower position to a second upper position against the lower surface of the ceiling.

The foregoing description of several embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A recessed luminaire installation mechanism (10), comprising:
at least one post (46,146) extending from one of a trim (20) or a trim ring (40,140);
at least one track (32, 132) for receiving said at least one post, said track disposed on the other of said trim or said trim ring;
said at least one track being generally helical to vary a height of said trim relative to a luminaire can (12) when said trim is rotated about a vertical axis (V_{A}).

2. The recessed luminaire installation mechanism of claim 1 wherein said trim ring comprises a plurality of posts extending radially inward.

3. The recessed luminaire of installation mechanism of claim 1 wherein said trim ring further comprises a plurality of springs (62,162) depending from said ring.

4. The recessed luminaire installation mechanism of claim 3 further comprising a spring retaining member (44) on said trim ring.

5. The recessed luminaire installation mechanism of claim 1, said at least one track having a vertical portion.

6. The recessed luminaire installation mechanism of claim 5, said at least one track having a being a slot which receives said post.

7. The recessed luminaire installation mechanism of claim 1, said at least one track being three tracks.

8. A recessed luminaire installation mechanism of claim 1, said at least one track located in said luminaire trim.

9. A recessed luminaire installation mechanism (10), comprising:
a recessed luminaire can (12);
a trim ring (40, 140) positioned within said can, said trim ring defining a first portion of a rotatable trim retaining mechanism;
a trim (20) defining a second portion of said rotatable trim retaining mechanism, said trim engaging said trim ring to retain said trim within said can;
said trim being rotatable relative to said trim ring causing said trim to move from a first vertical position to a second vertical position;
one of said first vertical position and said second vertical position disposing a trim flange (26) against a lower ceiling surface (C).

10. The recessed luminaire installation mechanism of claim 9, said trim ring further comprising a plurality of springs (60, 162).

11. The recessed luminaire installation mechanism of claim 9, said trim ring having one of a post (46,146) or a thread (32, 132) and said trim having the other of said post or said thread.

12. The recessed luminaire installation mechanism of claim 11 further comprising a starter thread (34, 134) disposed on said one of said trim and said trim ring.

13. The recessed luminaire installation mechanism of claim 12, said starter thread being vertical.

14. The recessed luminaire installation mechanism of claim 12, said starter thread being on an angle to a vertical axis.

15. The recessed luminaire installation mechanism of claim 12, said starter thread being in communication with said track.

16. A recessed luminaire installation mechanism (10), comprising:
a luminaire can (12) having an opening at one end;
a trim ring (40) having at least one spring (62, 162) which engages an inner surface of said luminaire can;
a trim structure (20) positioned within said luminaire can, said trim structure received by said trim ring;
an engaging structure (46,146) extending from one of said trim ring and said trim structure;
a receiving structure (32, 132) disposed on the other of said trim ring and said trim structure, said receiving structure receiving said engaging structure;
said receiving structure comprising a slot (36) which extends partially circularly so that rotation of said trim structure causes said trim structure to raise or lower from one of a first and second vertical position to the other of said first and second vertical position.

17. The recessed luminaire of claim 16, said receiving structure comprising at least one helical slot.

18. The recessed luminaire of claim 17, said receiving structure further comprising a vertical slot portion.

19. The recessed luminaire of claim 16 wherein rotation of said trim structure tightens said trim structure against said ceiling.

20. The recessed luminaire of claim 16 wherein said engaging structure is positioned on said trim ring.

21. The recessed luminaire of claim 16 wherein said engaging structure is positioned on said trim structure.

22. The recessed luminaire of claim 16 further comprising at least one protuberance along said receiving structure.

23. The recessed luminaire of claim 16, said receiving structure comprising a frictional increasing surface.

24. A method of installing a recessed luminaire trim, comprising:
installing a recessed luminaire can (12) into a ceiling (C);
positioning a trim (20) within said recessed luminaire can;
rotating said trim to raise said trim from a first position to a second position;
engaging said ceiling with a trim flange (26) at said second position.

25. A method of installing a recessed luminaire trim, comprising:
positioning a trim ring (40) within a recessed luminaire can (12);
installing a recessed luminaire into a ceiling (C);
positioning a trim (20) into a trim ring (40);
rotating said trim ring relative to said trim ring;
raising said trim relative to said trim ring to engage a surface of a trim flange (26) with said ceiling.
